(19) United States
(12) Patent Application Publication
(10) Pub. No.: US 2009/0164065 A1
(43) Pub. Date: Jun. 25, 2009

(54) TRACK PROTECTION SYSTEM

(75) Inventors: Christopher E. Daniels, Fuquay-Varina, NC (US); Brent M. Hunold, Holly Springs, NC (US); Christopher J. Neiger, Apex, NC (US); Sage F. Smith, Apex, NC (US); Haim Bear, Apex, NC (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/169,092

(22) Filed: Jul. 8, 2008

Related U.S. Application Data
(60) Provisional application No. 61/015,770, filed on Dec. 21, 2007.

(51) Int. Cl. B62D 11/00

(52) U.S. Cl. 701/41

(57) ABSTRACT

A tracked machine may include a first track, a second track, and a drive system configured to move the first track in a first direction and move the second track in a second direction. The tracked machine includes an operator input system and an electronic control module in electrical communication with the operator input system and the drive system to receive an input signal from the operator input system indicating a first movement direction and a first speed for the first track and a second movement direction and a second speed for the second track. The electronic control module compares the first movement direction with the second movement direction and generates a drive signal to actuate the first and second tracks to move in the same direction when the first movement direction is different than the second movement direction.

### CROSS-REFERENCE TO RELATED APPLICATIONS

This application claims the benefit of U.S. Provisional Application No. 61/015,770, filed Dec. 21, 2007.

### TECHNICAL FIELD

This invention relates generally to a control system and method for track-type machines, and more specifically, a control system and method for minimizing track wear.

### BACKGROUND

Tracked machines, such as track-type tractors, skid steer loaders, and the like, are used to perform a variety of work functions under conditions which require an amount of traction not available with conventional wheeled machines. The tracked machines typically are driven by some type of differential transmission system, which applies the driving force to each of a left and a right track. Generally, the tracked machines are steered by controlling the speed of each track; that is, if it is desired to turn to the left, the left track is made to move slower compared to the right track to effectuate the turn. Additionally, tracked machines are capable of making zero radius or small radius turns where one track is moved in one direction and the other track is moved in the opposite direction or is stopped.

Unfortunately, when a tracked machine is caused to make zero radius or small radius turns, the tracks wear at an accelerated rate. This wear rate may be severe on machines, such as multi-terrain skid steer loaders that use rubber, plastic, and/or composite tracks. Track wear may be further accelerated by novice operators who tend to operate the tracked machine harder and make more zero radius or small radius turns than experienced operators.

The present invention is directed to overcome one or more of the problems, as set forth above.

### SUMMARY OF THE INVENTION

In one example of the present invention, a system and method is provided for minimizing wear on the tracks of a tracked vehicle. The method for controlling the tracked machine including a first track, a second track, and an operator input system may comprise the steps of receiving an input signal from the operator input system indicating a first movement direction for the first track and a second movement direction for the second track. The method may also include the step of comparing the first movement direction with the second movement direction and generating a drive signal to actuate the first and second tracks to move in the same direction when the first movement direction is different than the second movement direction.

The tracked machine implementing this method may also include a drive system configured to move the first track in a first direction and at a first speed and move the second track in a second direction and at a second speed and an electronic control module in electrical communication with the operator input system and the drive system. The electronic control module may be configured to receive an input signal from the operator input system indicating a first movement direction and a first speed for the first track and a second movement direction and a second speed for the second track. The electronic control module may compare the first movement direction with the second movement direction and generate a drive signal to actuate the first and second tracks to move in the same direction when the first movement direction is different than the second movement direction.

In a more specific example, the tracked machine may be a multi-terrain skid steer loader that includes a first and second track that each includes a polymeric surface layer. The multi-terrain skid steer loader may also include a drive system configured to move the first track in a first direction and at a first speed and move the second track in a second direction and at a second speed. An operator input system may include a first joystick for providing a first input signal indicating a direction and speed for the first track and a second joystick for providing a second input signal indicating a direction and speed for the second track.

Additionally, the multi-terrain skid steer loader may include an electronic control module in electrical communication with the operator input system and the drive system. The electronic control module may be configured to receive the first input signal and the second input signal and compare the first input signal with the second input signal. The electronic control module generates a drive signal to actuate the first and second tracks to move in the same direction when the first movement direction is different than the second movement direction. The electronic control module may also determine an input travel direction from the first input signal and the second input signal. The input travel direction may be compared with a minimum turn radius so that the first and second tracks are actuated to move the tracked machine along a radius equal to or greater than the minimum turn radius.

### BRIEF DESCRIPTION OF THE DRAWINGS

FIG. 1 is a side view of a tracked machine and more specifically, a multi-terrain skid steer loader.

FIG. 2 is a schematic view of a track protection system for the tracked machine of FIG. 1.

FIG. 3 is a flow diagram illustrating a method for limiting track wear.

### DETAILED DESCRIPTION

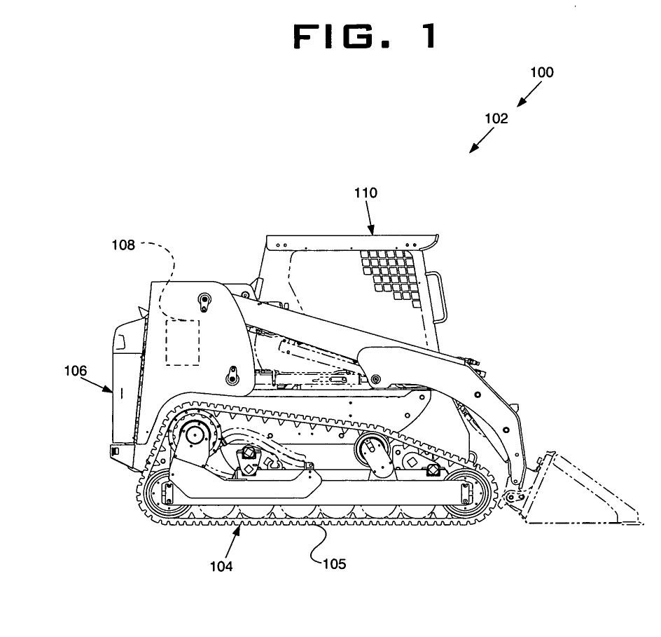

Referring to FIG. 1, a side view illustrates a tracked machine 100. As shown, the tracked machine may be multi-terrain skid steer loader 102. Of course, the tracked machine 100 may be a track-type tractor, tracked loaders, tracked excavators, agricultural tracked machines, and other tracked machines known in the art.

Tracked machines 100 offer the advantage of increased traction in difficult terrain, and in some instances reduced compression of the soil traveled upon. However, tracked machines 100 present challenges not normally encountered with wheeled machines, particularly with wear on the tracks 104.

The tracks 104 may have a polymeric surface layer 105 and may be made predominantly of a polymer. In some configurations, the tracks 104 may be made of a vulcanized rubber or a composite that may include steel reinforcements. The tracks 104 may also be made of a metal, such as steel, and may be covered by an elastomeric surface layer 105 for improved traction.

The tracked machine 100 may also include an engine compartment 106 and a mode selection device 108 that may be disposed within the engine compartment 106. The mode selection device 108 will be discussed in detail below and may be disposed elsewhere on the tracked machine 100, such as in an operator compartment 110, or in a housing for an electronic control module (not shown).

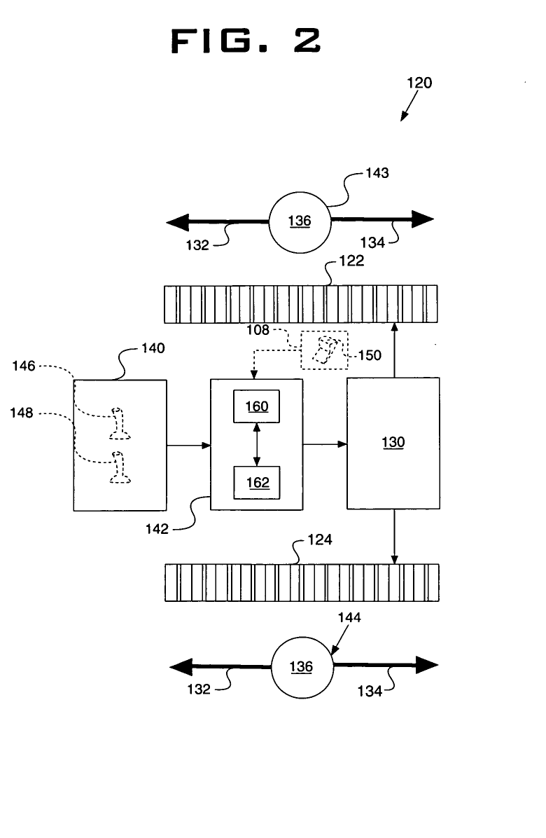

Referring to FIG. 2, a schematic view illustrates a track protection system 120 for the tracked machine 100 of FIG. 1. As shown, the tracks 104 of the tracked machine 100 include a first track 122 and a second track 124. The first track 122 may be the right or left track 104 of the tracked machine 100 and the second track 124 may be the other of the tracks 104 of the tracked machine 100.

The tracks 104 may be actuated by a drive system 130. The drive system 130 may be configured to move the first track 122 in a first direction and at a first speed and move the second track 124 in a second direction and at a second speed. In other words, the drive system 130 may be selectively directed to move one or both of the first and second tracks 122, 124 in a forward direction 132, a reverse direction 134, and a neutral direction 136.

For example, the first track 122 and the second track 124 may be directed to move in different directions or the same direction such as in a forward direction 132, a reverse direction 134, and a neutral direction 136. When the drive system 130 is actuated to move the first or second tracks 122, 124 in the neutral direction 136, the first or second tracks 122, 124 is stopped.

The drive system 130 may include an engine (not shown) and a transmission system (not shown) known in the art such as a dual-path hydrostatic transmission (not shown). The transmission system may also be a mechanical transmission having a clutch and gear system (not shown), a hydro-mechanical transmission (not shown), such as a split-torque transmission (not shown), and a hydro-kinetic transmission having a torque converter system (not shown). Consequently, the drive system 130 may include pumps, motors, valves, gears, sensors and other components known in the art. Alternatively, the drive system 130 may also include electric motors and batteries or fuel cells that provide electrical power to electric motors that actuate the tracks 104. These types of drive systems 130 are all well known in the art and are not discussed further.

The track protection system 120 may also include an operator input system 140 and an electronic control module 142 in electrical communication with the operator input system 140 and the drive system 130. The operator input system 140 generates an input signal, which is sent to and received by the electronic control module 142. The input signal may indicate a first movement direction 143 and a first speed for the first track 122 and a second movement direction 144 and a second speed for the second track 124.

The operator input system 140 may include a wide variety of operator input devices such as a steering wheel, levers, switches, buttons, keypads, touch screen displays, a radio frequency or infrared receiver for remote control, and other operator input devices known in the art. As shown, the operator input system 140 may optionally include a first joystick 146 and a second joystick 148.

In configurations where the first and second joysticks 146, 148 are used, the input signal may include a first input signal and a second input signal. Specifically, the first joystick 146 may provide a first input signal indicating a direction and speed for the first track 122 and the second joystick 148 may provide a second input signal indicating a direction and speed for the second track 124.

When the electronic control module 142 receives the first and second input signals, the electronic control module may use the input signals to generate and send a drive signal to the drive system 130 to respectively actuate the first and second tracks 122, 124. Consequently, the operator input system 140 may provide an input signal directing the electronic control module 142 to send a drive signal to move the first track 122 in the forward direction 132 and the second track 124 in the reverse or neutral direction 134, 136. Additionally, the first and second tracks 122, 124 may be directed by the operator input system 140 to move in the same direction at the same speed or at different speeds.

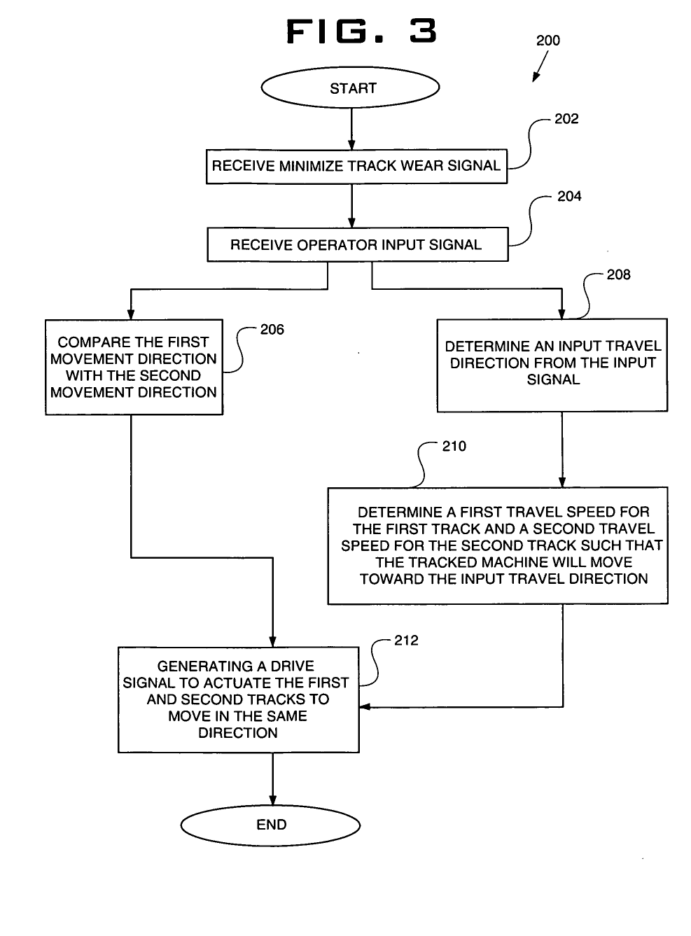

The track protection system 120 may also include the mode selection device 108 shown in FIG. 1. The mode selection device 108 may be actuated to send a minimize track wear signal to the electronic control module 142 to initiate a minimize track wear control method 200 (shown in FIG. 3) for the tracked machine 100. In other words, the mode selection device 108 may permit an operator, technician or other user of the tracked machine 100 to select whether the electronic control module 142 will use the minimize track wear control method 200. In some configurations, the mode selection device 108 may be a switch 152.

As shown in FIG. 1, the mode selection device 108 may be mounted within the engine compartment 106. This may be desirable where the tracked machine 100 is used as a rental machine or may be operated by novice operators. Consequently, an owner of the tracked machine 100 can initiate the minimize track wear control method 200 (shown in FIG. 3) when a novice user will operate the machine and disengage the minimize track wear control method 200 when a more experienced user will be operating the tracked machine 100. More specifically, by placing the mode selection device 108 within the engine compartment 106, a novice operator or rental customer may be less likely to disengage the minimize track wear control method 200 contrary to the wishes of the owner of the tracked machine 100.

Alternatively, the operator input system 140 may be actuated to send a minimize track wear signal to the electronic control module 142. For example, in configurations where the operator input system 140 includes a display, the minimize track wear control method 200 (shown in FIG. 3) may be selected from a software menu. In another configuration, the electronic control module 142 may include a data port (not shown) connected to the electronic control module 142 that permits a technician to select and initiate the minimize track wear control method 200 via a handheld computer (not shown). The handheld computer may also be used to read fault codes and review program settings for the electronic control module 142.

The electronic control module 142 may include one or more central processing units 160 and computer readable media 162 for storing instructions for implementing the minimize track wear control method 200 (shown in FIG. 3). The computer readable media 162 may include hard disks, floppy disks, flash drives, CD-ROM, DVD-ROM and other forms of RAM or ROM known in the art.

Referring to FIG. 3 and in view of FIG. 2, a flow diagram illustrates the minimize track wear control method 200. The minimize track wear control method 200 may be stored in the computer readable media 162 and implemented by the central processing unit 160 of the electronic control module 142.

The minimize track wear control method 200 may include the step 202 of receiving a minimize track wear signal. As discussed above, the minimize track wear signal may be generated by actuating the mode selection device 108 or operator input system 140 of FIG. 2. Alternatively, the electronic control module 142 may receive the minimize track wear signal by being directly programmed by a technician to implement the minimize track wear control method 200. Once received, the electronic control module 142 applies instructions that may be stored within the computer readable media 162.

The method may include the step 204 of receiving an input signal from the operator input system 140. The input signal may indicate the first movement direction 143 for the first track 122 and the second movement direction 144 for the second track 124. The input signal may also indicate a first speed and a second speed for the respective first and second tracks 122, 124.

In configurations where the operator input system 140 includes the first joystick 146 and the second joystick 148, the input signal may include the first input signal and the second input signal. More specifically, the first joystick 146 may provide the first input signal indicating the first movement direction 143 for the first track 122 and the second joystick 148 may provide the second input signal indicating second movement direction 144 for the second track 124.

The method may include the step 206 of comparing the first movement direction 143 with the second movement direction 144.

In some configurations, the method may include the step 208 of determining an input travel direction from the input signal. The input travel direction may be used in step 210 of the method to determine a first travel speed for the first track 122 and a second travel speed for the second track 124 such that the tracked machine 100 will move toward the input travel direction.

The method may include the step 212 of generating a drive signal to actuate the first and second tracks to move in the same direction when the first movement direction 143 is different than the second movement direction 144. In some configurations, the drive signal may cause the first and second tracks 122, 124 to both move in the forward direction 132. Alternatively, the drive signal may cause the first and second tracks 122, 124 to both move in the neutral direction 136.

In configurations where the drive signal causes the first and second tracks 122, 124 to both move in the forward direction 132, the drive signal may cause the drive system 130 to move each of the first and second tracks 122, 124 at a travel speed equal to or greater than a predetermined minimum speed. In this case, the predetermined minimum speed may be used to determine a minimum turn radius that the tracked machine 100 is capable of moving through while implementing the minimize track wear control method 200. Alternatively, the minimum turn radius may be used to determine the minimum speed with which the first and second tracks 122, 124 may be actuated to move in the forward or reverse directions 132, 134.

Consequently, step 212 may include comparing the input travel direction with a minimum turn radius so that the first and second tracks 122, 124 are actuated to move the tracked machine 100 along a radius equal to or greater than the minimum turn radius. Alternatively, step 212 may include comparing the first and second travel speeds with a predetermined minimum speed so that the first and second tracks 122, 124 both move at a speed equal to or greater than the predetermined minimum speed.

Both the predetermined speed and the predetermined radius are optional and in some configurations may be used together to prevent accelerated track wear. Additionally, they may be selected by an owner and input into the electronic control module 142 via the operator input system, the mode selection device, or directly input into the electronic control module 142 via a data port.

### INDUSTRIAL APPLICABILITY

As an example of an application of the present invention, an owner of the tracked machine 100, such as a multi-terrain skid steer loader 102, may implement the minimize track wear control method 200. Consequently, novice operators and renters may be prevented from making turns that accelerate track wear. For example, counter rotation of the first and second tracks 122, 124 may be prevented, as well as, rotation of a single track while the other is held in neutral. In both of these turns, the soft polymer surface layer 112 of the tracks 104 may be quickly eroded forcing repair or replacement of the tracks 104. Consequently, the minimize track wear control method 200 can be utilized to extend the life of the tracks 104 when the tracked machine 100 is used by novice operators or in rental and training environments.

It will be apparent to those skilled in the art that various modifications and variations can be made without departing from the scope or spirit of the invention. Additionally, other embodiments of the invention will be apparent to those skilled in the art from consideration of the specification and practice of the invention disclosed herein. It is intended that the specification and examples be considered as exemplary only.

What is claimed is:

1. A method for controlling a tracked machine, the tracked machine including a first track, a second track, and an operator input system, the method comprising:
receiving an input signal from the operator input system indicating a first movement direction for the first track and a second movement direction for the second track;
comparing the first movement direction with the second movement direction; and
generating a drive signal to actuate the first and second tracks to move in the same direction when the first movement direction is different than the second movement direction.

2. The method of claim 1, wherein the drive signal actuates the first track to move at a first travel speed equal to or greater than a predetermined minimum speed and the second track to move at a second travel speed equal to or greater than a predetermined minimum speed.

3. The method of claim 1, wherein the step of receiving an input signal includes receiving a first input signal from the operator input system indicating a first movement direction and a first speed for the first track and a second input signal from the operator input system indicating a second movement direction and a second speed for the second track.

4. The method of claim 1, wherein the step of generating a drive signal, the first and second tracks are both actuated to move in a forward direction.

5. The method of claim 1, wherein the step of generating a drive signal to actuate the first and second tracks to move in the same direction, wherein the first and second tracks are both actuated to a neutral direction.

6. The method of claim 1, wherein the tracked machine further includes a mode selection device, the method further comprising the step of receiving a track wear prevent mode signal from the mode selection device.

7. The method of claim 1, further comprising the step of determining an input travel direction from the first input signal with the second input signal and comparing the input travel direction with a minimum turn radius, wherein the first and second tracks are actuated to move the tracked machine along a radius equal to or greater than the minimum turn radius.

8. The method of claim 1, further comprising the step of determining an input travel direction from the input signal and determining a first travel speed for the first track and a second travel speed for the second track such that the tracked machine will move toward the input travel direction when the first movement direction is different than the second movement direction.

9. The method of claim 1, wherein the tracked machine is a multi-terrain skid steer loader, wherein the first and second tracks have a polymeric surface layer.

10. A tracked machine comprising:
a first track;
a second track;
a drive system configured to move the first track in a first direction and at a first speed and move the second track in a second direction and at a second speed;
an operator input system; and
an electronic control module in electrical communication with the operator input system and the drive system, the electronic control module being configured to receive an input signal from the operator input system indicating a first movement direction and a first speed for the first track and a second movement direction and a second speed for the second track, wherein the electronic control module includes a track wear prevent mode, wherein when the electronic control module is in the track wear prevent mode, the electronic control module compares the first movement direction with the second movement direction and generates a drive signal to actuate the first and second tracks to move in the same direction when the first movement direction is different than the second movement direction.

11. The tracked machine of claim 10, wherein the drive signal causes the drive system to move each of the first and second tracks at a travel speed equal to or greater than a predetermined minimum speed.

12. The tracked machine of claim 10, wherein the electronic control module determines an input travel direction from the input signal and uses the input travel direction to determine a first travel speed for the first track and a second travel speed for the second track such that the tracked machine will move toward the input travel direction when the first movement direction is different than the second movement direction.

13. The tracked machine of claim 10, wherein the electronic control module determines an input travel direction from the first input signal with the second input signal and compares the input travel direction with a minimum turn radius, wherein the first and second tracks are actuated to move the tracked machine along a radius equal to or greater than the minimum turn radius.

14. The tracked machine of claim 10, wherein the input signal includes a first input signal indicating a first movement direction and a first speed for the first track and a second input signal indicating a second movement direction and a second speed for the second track.

15. The tracked machine of claim 10, further comprising a mode selection device, wherein the mode selection device is actuated to send a track wear prevent mode signal to the electronic control module to initiate the track wear prevent mode.

16. The tracked machine of claim 15, wherein the mode selection device is a switch.

17. The tracked machine of claim 16, wherein the switch is disposed within an engine compartment of the tracked machine.

18. The tracked machine of claim 10, wherein the drive signal causes the first and second tracks to both move in a forward direction when the first movement direction is different than the second movement direction.

19. The tracked machine of claim 18, wherein the tracked machine is a multi-terrain skid steer loader, wherein the first and second tracks have a polymeric surface layer.

20. A multi-terrain skid steer loader comprising:
a first track including a polymeric surface layer;
a second track including a polymeric surface layer;
a drive system configured to move the first track in a first direction and at a first speed and move the second track in a second direction and at a second speed;
an operator input system including a first joystick for providing a first input signal indicating a direction and speed for the first track and a second joystick for providing a second input signal indicating a direction and speed for the second track; and
an electronic control module in electrical communication with the operator input system and the drive system, the electronic control module being configured to receive the first input signal and the second input signal, wherein the electronic control module compares the first input signal with the second input signal, wherein the electronic control module generates a drive signal to actuate the first and second tracks to move in the same direction when the first movement direction is different than the second movement direction, wherein the electronic control module determines an input travel direction from the first input signal and the second input signal and compares the input travel direction with a minimum turn radius, wherein the first and second tracks are actuated to move the tracked machine along a radius equal to or greater than the minimum turn radius.
